(19) United States
(12) Patent Application Publication
(10) Pub. No.: US 2009/0275331 A1
(43) Pub. Date: Nov. 5, 2009

(54) SYSTEM AND METHOD FOR ACCESSING MOBILE DATA DEVICES

(75) Inventors: RANGANATH Maitreya, Singapore (SG); Pimpin KWALA, Singapore (SG); Sze Shyang WANG, Singapore (SG); Yi LI, Singapore (SG); Sharib ANIS, Singapore (SG); Varun ARORA, Singapore (SG); Satish Kumar VITHANALA, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(73) Assignee: WIRELESS INTELLECT LABS PTE LTD, Singapore (SG)

(21) Appl. No.: 12/504,656

(22) Filed: Jul. 16, 2009

Related U.S. Application Data
(63) Continuation of application No. 10/560,738, filed on Dec. 15, 2005.

(30) Foreign Application Priority Data
Jul. 3, 2003 (SG) 200304008-6

(51) Int. Cl. H04W 60/00

(52) U.S. Cl. 455/435.1

(57) ABSTRACT

An intermediate system (20,30) for managing mobile data devices (22,32) is disclosed. The intermediate system (20,30) for accessing mobile data devices (22,32) and the method for implementing thereof, allows data requesters (24,34) on a network interconnected (31) with a mobile network (21) to which are connected mobile data devices (22) to access content from these mobile data devices (22,32) without knowing the MSISDNs or mobile data device identifiers of these mobile data devices (22,32) and without individually monitoring the availability of these mobile data devices (22,32).

### REFERENCE TO RELATED APPLICATION

The present application is a continuation of U.S. utility application Ser. No. 10/560,738, filed on Dec. 15, 2005.

### FIELD OF INVENTION

The invention relates to an intermediate system for mobile data collection devices. Specifically, the invention relates to an improved access methodology and system that enables content requesters, whether on a mobile or fixed network, to access mobile data devices, including mobile cameras, mobile measurement and scanning devices, and other type of mobile content device, by way of an intermediate system.

### BACKGROUND OF INVENTION

Recent developments in mobile communication networks have resulted in increasing of bandwidth available to mobile device users. Classic examples of such mobile devices are mobile phones which have become an essential implement in our daily lives. With this increase in bandwidth, it is now feasible for mobile device users to use their devices for data transmitting and receiving purposes, such as accessing pictures, sound, and video. PCs and other such communication devices have already been in use to access such data for some time.

Presently, a new class of mobile data devices are emerging that can operate on a mobile network and can respond to content requests sent over the mobile network. Such mobile data devices could comprise any number of data collection devices which can accommodate data requests such as audio, video, ambient temperature, lighting, the presence or absence of chemicals, other environmental factors, or other forms of data content

At present, these mobile data devices require a requester to send their requests to be sent to the mobile data device's Mobile Station International Subscriber Device Number (MSISDN) or more often referred to as the “mobile phone number”. These mobile data devices then determine whether the requester has authorized access to the content that the mobile data device may deliver. The mobile data device checks the MSISDN of the requestor's mobile device and compares it with a look up table comprising authorized MSISDNs to determine if the requestor is authorized.

A drawback of the abovementioned method is that a requester is required to know the MSISDN of each of the mobile data devices. This problem may be overcome by the requester storing the MSISDN of the mobile data device on his own mobile device (such as in a mobile-phone's phonebook/addressbook). However, this is a sub-optimal solution if a large number of mobile data devices are available, in which case the requester must store the MSISDN of each of those mobile data devices that he is interested in and must assign meaningful names to each mobile data device MSISDN so stored. Furthermore, he will need to continuously update this record as additional mobile data devices of interest become available to him, or as mobile data devices are removed, or if a mobile data device's MSISDN is changed for any reason.

Another drawback of this system is that the requester currently sends a request to the mobile data device by using a Short Messaging Service (SMS) message. This becomes a concern if the requester is not a mobile network user but is a fixed-line user.

Another drawback of the aforementioned method is that there is no practical method provided for the requester to determine whether the mobile data device is actually available at the time of request. As a consequence, the user has no way of knowing whether his content requests can be responded to.

Still another drawback of the aforementioned method is that memory capacity of these mobile data devices have so far been limited. This results in the mobile data device being able to store only a limited number of authorized requester MSISDNs. So, by way of example, if the mobile data device has a capacity of 20 authorized requester MSISDNs, then the mobile data device may not be able to support any additional requester MSISDNs, resulting in the mobile data device being usable by only the 20 permitted requesters.

As an alternative, the mobile data device may be accessible by all requesters, with no restrictions at all. This either- or scenario becomes a serious limitation, especially if the owner of the mobile data device intends to use the device for commercial purposes where, by way of example, he proposes to charge requesters for the right to access the mobile data device and where he proposes to limit access to a specific mobile data device to only those requesters who have paid or have indicated a willingness to pay for the right to access the mobile data device. This is an inherent limitation of such an approach and, despite falling memory prices and continuing memory miniaturization, will continue to be a drawback due to inherent size/storage/power trade-offs in a mobile data device.

Yet another drawback of the aforementioned approach is that as the MSISDN of the mobile data device must be known to a potential requester, the said requester may attempt to use this MSISDN for malicious purposes, such as continuous transmission of requests to the MSISDN of the mobile data device, thus making the mobile data device unavailable to other potential requesters, or making voice-calls to the MSISDN of the mobile data device and potentially similarly making the mobile data device unavailable to other potential legitimate users, and other forms of denial of service to other legitimate users, and also other forms of potential fraud.

Another drawback of the aforementioned approach is that as the mobile data device responds directly to the requester, through the mobile network, there is no specific provision for centralized logging of use for administrative analysis, marketing analysis, and the prevention or discouragement of immoral/improper use of a mobile data device.

Finally, another drawback of the aforementioned approach is that typical network configurations either do not permit mobile data requesters on one network to request data from mobile data devices on another network or do not permit the responses from the mobile data devices on one network to be sent back to mobile data requesters on another network.

Hence, this clearly affirms a need for an improved access methodology, using an intermediate system for accessing mobile data devices, to address the foregoing disadvantages of conventional access methodologies and systems.

### SUMMARY OF INVENTION

The present invention relates to managing access of a plurality of mobile data devices connected to a network using an intermediate system.

Accordingly, in one embodiment, the present invention provides a system for managing access to a mobile data collection device. The system comprises: a mobile communication network; one or more mobile data collection device(s) connectable to said mobile communication network; and an intermediate system connectable to said mobile communication network; wherein said intermediate system is operable to: a) assign each said one or more mobile data collection device(s) with a unique name and register each said unique mobile data collection device in a lookup table in a database; b) register one or more data requestor(s) and create an access list of mobile data collection device(s) for each data requester; and c) when a data request is received by the mobile communication network and access right of the requester is verified from said access list, direct the relevant mobile data collection device to respond, so that the data requester has no knowledge of the identity and availability of the responding mobile data collection device.

In another embodiment of the present invention, the communication network is connectable to another communication network. The another communication network has an associated intermediate system, one or more associated data collection device(s); and one or more associated data requestor(s). The associated intermediate system is operable to: a1) assign each said one or more associated data collection device(s) with a unique name and register each said unique data collection device in a lookup table in an associated database; b1) register one or more data requestor(s) and create an access list of data collection device(s) for each said data requester; and c1) when a data request is received by said communication network and access right of the requester is verified from said access list, direct the relevant data collection device to respond, so that the data requestor has no knowledge of the identity and availability of the responding data collection device.

In one embodiment of the present invention, the communication network and the another communication network comprise communication networks that operate on similar protocols. In another embodiment, the communication network and the another communication network comprise communication networks that operate on different protocols. The intermediate system and associated another intermediate system allow a data requester to access a data collection device on another communication network. In addition, the intermediate systems may be made via a shared network.

In another embodiment of the present invention, access to the data collection device is initiated by a data request, execution of an event, or trigger by a stimulus. In one embodiment, the stimulus is any one of the following: motion detection, change in temperature, change in humidity, change in count, and trigger from an instrument/a controller.

In another embodiment of the present invention, the unique name of said data collection device comprises a content description or content category of the data provided by said data collection device. In addition, registering a data collection device comprises identifying the data collection device by its MSIDSN, IMEI and/or IP address.

### BRIEF DESCRIPTION OF DRAWINGS

Embodiments of the invention are described hereinafter with reference to the following drawings, in which:

FIG. 1 shows a flow diagram of a method for managing access for mobile data devices in accordance with the present invention;

FIG. 2 shows a system layout diagram for managing access for mobile data devices in accordance with the present invention;

FIG. 3 shows the steps of registering mobile data devices of FIG. 1;

FIG. 4 shows the steps of generating a list of available mobile data devices of FIG. 1;

FIG. 5 shows the steps of receiving a data request of FIG. 1; and

FIG. 6 shows the steps of an alternative embodiment of receiving a data request of FIG. 1.

### DESCRIPTION OF INVENTION

A system and method for managing access to a plurality of Mobile Data Devices connected to a network using an intermediate system for addressing the foregoing problems is described hereinafter.

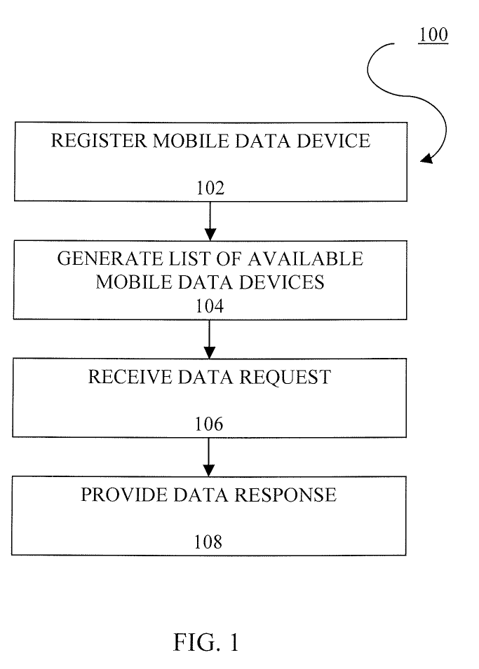

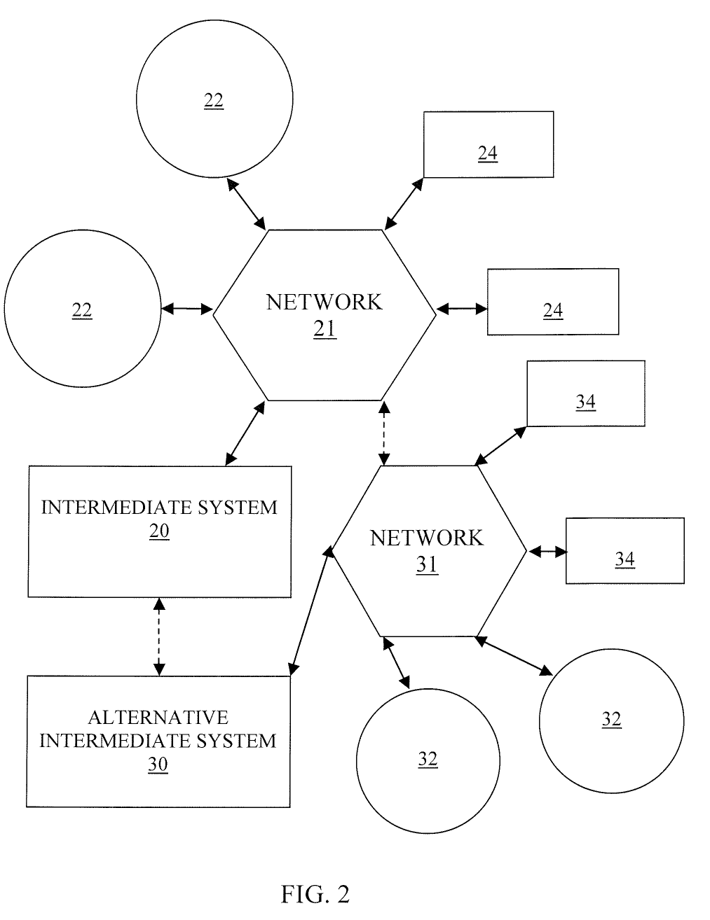

According to an embodiment of the invention, a system for managing in accordance with the present invention, as shown in FIG. 2, for implementing method 100 in accordance with the present invention is described with reference to FIG. 1.

Referring to FIG. 2, a system in accordance with the present invention comprises a first Network 21, a intermediate system 20, a plurality of data requesters 24, and a plurality of Mobile Data Devices 22.

The plurality of data requesters 24, the plurality of Mobile Data Devices 22 and the intermediate system 20 are interconnected over a Network 21. The Network 21 is a mobile cellular network which may operate on any of several known mobile cellular systems, non limiting examples of which are: GSM, GPRS, UMTS, and WCDMA.

There may be more than one Network, a non limiting illustration being an alternate Network 31 which similarly interconnects a plurality of alternate data requesters 34, a plurality of alternate Mobile Data Devices 32 and an alternate intermediate system 30. The present invention is not limited by number and different telecommunication providers using a variety of different protocols or transmission methods.

The alternate Network System 31 may be in direct communication with the Network System 21 or may communicate over a shared network such as the Internet. The alternate Network System 31 may also be in communication with the Network System 21 via their respective Intermediate systems 20, 30. The alternate Intermediate system 30 may be in direct communication with the Network System 20 or may communicate over a shared network such as the Internet.

Interaction between the plurality of Mobile Data Devices 22, the first plurality of data requesters 24, the intermediate system 20 and the network 21 are also similarly applicable to the alternate Network 31 and its interconnected devices.

The plurality of Mobile Data Devices 22 are wherefrom data originates. These Mobile Data Devices 22 may operate independently or under the control of the Intermediate System 20 which is connected to the Network 21. The plurality of data requesters 24 would only access data from the first plurality of Mobile Data Devices 22 through the Intermediate System 20.

The plurality of Mobile Data Devices 22 may send and receive signals over the Network 21. The Mobile Data Devices 22 may require specific software or other customisation to enable the Mobile Data Devices 22 to communicate with the Intermediate System 20.

Referring to FIG. 1, the method 100 in accordance with the present invention is for managing access to the plurality of Mobile Data Devices 22 by the plurality of data requesters 24. The method 100 starts with step 102 where the plurality of Mobile Data Devices 22 are first registered with the Intermediate System 20.

Next, a list of available Mobile Data Devices 22 is generated by the first Intermediate System 20 in step 104. The Mobile Data Devices 22 contained in the list of available Mobile Data Devices 22 are for the provision of data therefrom.

Following step 104, the receiving of a data request by the Intermediate System 20 occurs in step 106. In response to the data request, the Intermediate System 20 provides a data response to the data requester 24 in step 108. The data request may be initiated by the data requester 24 or may be initiated by an event, an example of which is a timer-based event. The data request may also be initiated by other external stimulus, non limiting examples of which are: motion detection, change in temperature, change in humidity, change in count, and input triggers from instruments or controllers.

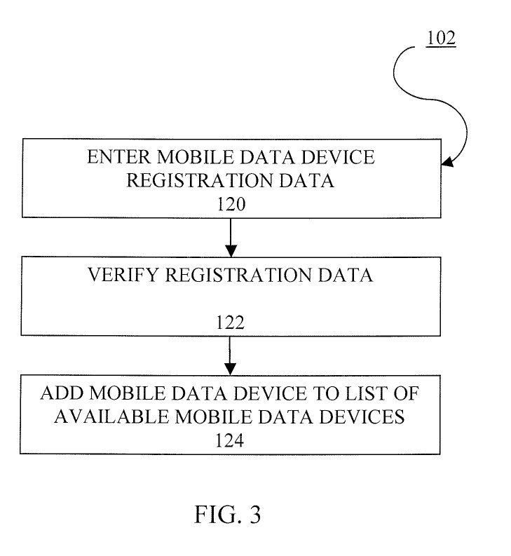

Referring to FIG. 3, the step 102 for registering the Mobile Data Devices further starts with the entering of registration data of the Mobile Data Devices 22 in step 120. This registration may be performed over the Internet by having an online form filled up where a unique name is assigned to each Mobile Data Device 22 and whereby a Mobile Data Device identifier, a non limiting example being the Mobile Data Device's MSISDN is assigned to this unique name. The Mobile Data Device's MSISDN is used as a non limiting example of the Mobile Data Device identifier throughout the description. Alternatively, the registration may further be performed via WAP or by entry by a system administrator or authorized officer via a client-server network. Yet in a further alternative, the Mobile Data Device identifier assigned to the Mobile Data Device 22 may be an International Mobile Equipment Identifier (IMEI) number or an IP address of the Mobile Data Device 22.

Upon the entry of the Mobile Data Device's 22 registration data, the Intermediate System 20 may conduct a verification of the registration data by performing a test to establish communication with the Mobile Data Device 22 using the registration data in a step 122. The verification may further comprise of determining if the Mobile Data Device's 22 MSISDN or IMEI or IP address are valid numbers or in a valid format.

Once the registration data has been verified as in step 122, the Mobile Data Device 22 is added to the list of available Mobile Data Devices 22 in step 124 and the registration data of the Mobile Data Device 22 stored in a database in the Intermediate System 20. In circumstances where verification of data as in step 122, may not be possible, the verification may be optionally skipped and the Mobile Data Device 22 added into the list of available Mobile Data Devices 22 as in step 124.

When entering the registration data of the Mobile Data Devices 22 in step 120, content description and content category of the data provided by the Mobile Data Devices 22 may also be registered. The content category can then be used to identify the type of data provided by each of the Mobile Data Devices.

The registration data can further comprise an access list which contains a list of authorized data requesters 24 who have access rights to specific Mobile Data Device 22. The access list may contain MSISDNs, email addresses or unique data requester identifiers of the authorized data requesters 24. The data requester identifiers may also comprise of IP addresses of the data requesters 24.

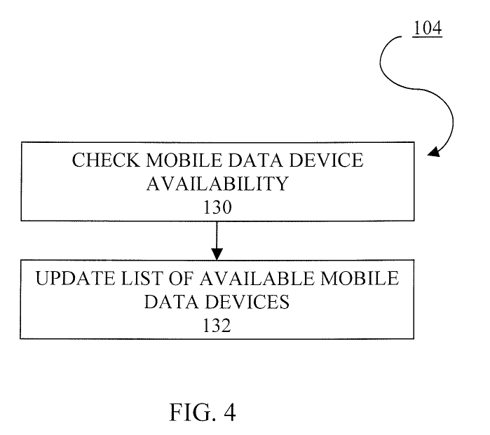

The list of available Mobile Data Devices is updated on the registration of a new Mobile Data Device 22 or on the modification of registration data of a previously registered Mobile Data Device 22. In the step 104, the generation of the list of available Mobile Data Devices 22 may also include checking for the availability of Mobile Data Devices 22 as shown in step 130 of FIG. 4. In step 130, the Intermediate System 20 periodically checks the accessibility of the Mobile Data Devices 22, and based on the response, updates the list of available Mobile Data Devices in step 132.

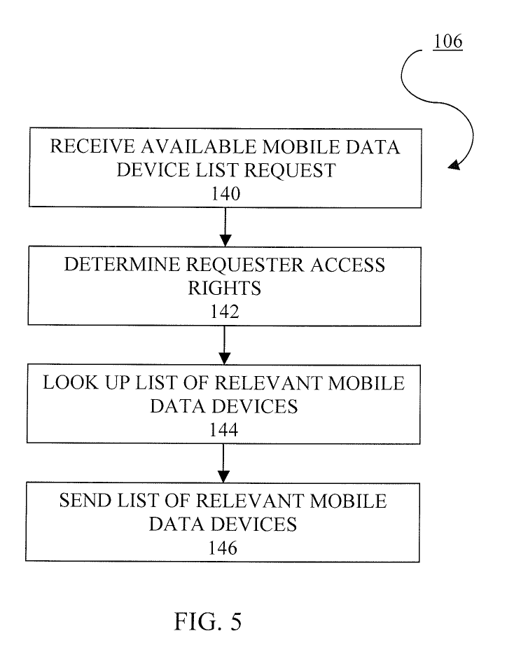

The Intermediate System 20 provides a mechanism for requesters 24 to determine the list of Mobile Data Devices 22 available to them. The Intermediate System 20 receives the data request in step 106 which may be a request for the list of Available Mobile Devices 20 as in step 140 of FIG. 5.

On receiving the request in step 140, the Intermediate System 20 determines the access rights of the data requester 24 by checking the data requester's 24 MSISDN or data requester identifier and then looking up a list of Mobile Data Devices 22 available to the relevant data requester 24 in step 144. This list may also include some alternate Mobile Data Devices 32 that are available to the data requester 24 by way of the alternate Intermediate System 30. The Intermediate System 20 may then respond to the data requester 24 by sending a list of relevant Mobile Data Devices 22 to the data requester in step 146 in a variety of ways, one of which could be via SMS.

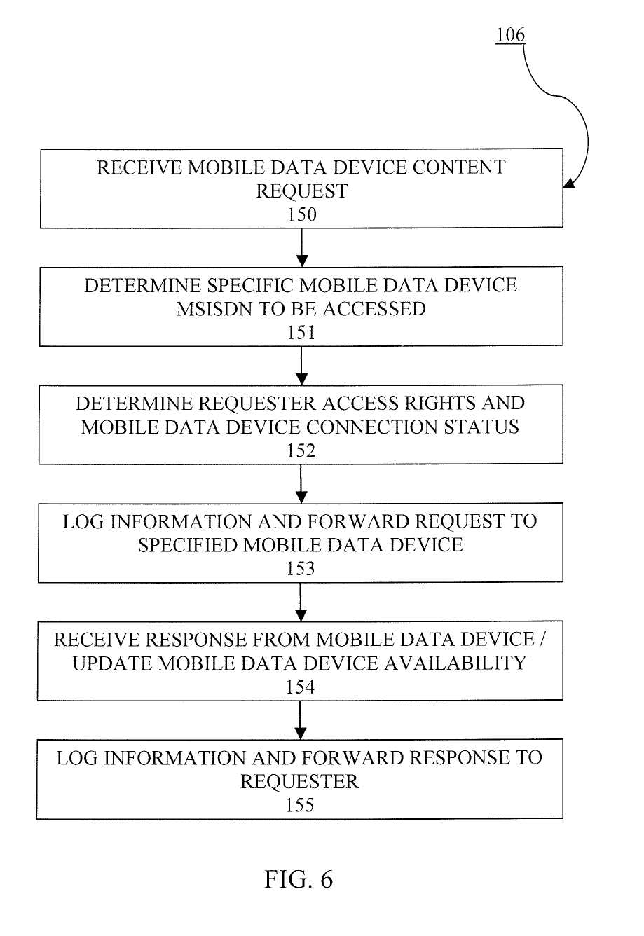

The Intermediate System 20 may also receive requests from data requesters 24 for content from specific Mobile Data Devices 22 or alternate Mobile Data Devices 32 in step 106. Referring to FIG. 6, the Intermediate System 20 receives a request for Mobile Data Device 22 content as in step 150, where the request may be made via SMS and contains the unique name assigned to the Mobile Data Device 22 wherefrom the content is desired. The Intermediate System 20 then proceeds to determine the MSISDN or the Mobile Data Device identifier of the specific Mobile Data Device 22 assigned the unique name.

In step 152, the Intermediate System 20 verifies whether the access rights of the data requester 24 to access content from the specified Mobile Data Device 22 and may also determine availability of the specified Mobile Data Device 22.

If the data requester 24 is authorized to access content from the specified Mobile Data Device 22 and if the specified Mobile Data Device 22 is available to transmit content, the Intermediate System 20 logs the request and instructs the specified Mobile Data Device 22 to acquire the required data and to send the required data to the data requestor 24 as in step 153. The format and the nature of the required data sent will depend on the specified Mobile Data Device's 22 capabilities, the nature of content, and the time-sensitivity required.

The Intermediate System 20 may further instruct the Mobile Data Device 22 to send the required data back to the Intermediate System 20 in step 154, and, in such a case, may also update the availability of the Mobile Data Device 22. In step 155, the Intermediate System 20 can then log the response of the Mobile Data Device 22 for administrative analysis or other purposes and may then forward the required data to the requester 24 using means most appropriate depending on the nature of content and the device capabilities of the requester 24. Any instructions pertaining to the specific content delivery mechanism may have been sent by the data requester 24 in the original request or stored in a requester profile in the Intermediate System 20.

If the Intermediate System 20 does not receive the response from the specified Mobile Data Device 22 within a predetermined period, the Intermediate System 20 may determine that the specified Mobile Data Device 22 is no longer available to receive data requests and may temporarily or permanently remove the specified Mobile Data Device 22 from the available Mobile Data Device list and may inform the data requester 24 regarding this lack of availability.

The Intermediate System 20 for Mobile Data Devices may instruct the specified Mobile Data Device 22 to directly transmit content to the requester 24, in which case no content will be received by the Intermediate System 20 from the specified Mobile Data Device 22, no data from the specified Mobile Data Device 22 will be logged, and no update of the Mobile Data Device availability list will be performed.

The Intermediate System 20 for Mobile Data Device may instruct the specified Mobile Data Device 22 to transmit the requested content directly to the specified requester 24 and also to transmit the requested content back to the Intermediate System 20 for Mobile Data Devices 22 for administrative analysis or other purposes.

The data requester 24 may request data of a particular content category or based on description keywords, without specifying any specific Mobile Data Device 22. The Intermediate System 20 will determine whether the requester 24 has access rights to content of the category or description specified.

Once the Intermediate System 20 determines that the specific requester 24 has the required rights, the Intermediate System 20 will then select any of the Mobile Data Devices 22 that offer content of the category or description requested by the requester 24 and are currently available to the requester 24, and may then follow steps 153, 154, and 155 as described earlier. If access is required from the alternate Mobile Data Device 32 on an alternate network 31, the Intermediate System 20 must first establish communication with the alternate Intermediate System 30 and will thence follow the method as described earlier. The alternate Intermediate System 30 will handle requests on behalf of the Intermediate System 20 to which the original requester 24 is connected.

The requester 24 may also request content from any one of a number of Mobile Data Devices 22 leaving the decision of the specific Mobile Data Device 22 to the Intermediate System 20. The Intermediate System 20 will select one of any of the Mobile Data Devices 22 that are currently available to the requester 24 and may then follow steps 153, 154, and 155 as described earlier. This selection process could be random or based on an alternative algorithm.

In all cases, the Mobile Data Devices 22 may send requested content to the Intermediate System 20 or to the data requester 24 via email. Alternatively, the Mobile Data Device 22 may send requested content to the Intermediate System 20 or to the data requester 24 via SMS or over WAP or other forms of data transfer.

The Mobile Data Device 22 may further make use of MMS (multimedia message service) to send requested content to the Intermediate System 20 or to the data requester 24. The precise mode used by the Mobile Data Devices 22 to send data either to the Intermediate System 20 or to the data requester 24 is dependent on the data transfer modes available to the specific Mobile Data Device 22 and the Intermediate System 20. It is also dependent on the capabilities of the specific Mobile Data Device 22 and the specific data requester 24.

The interaction between the alternate requesters 34, alternate Mobile Data Devices 32, and the alternate Intermediate System 30 is similar to the description above. If access is required from the alternate Mobile Data Device 32 on an alternate network 31, the Intermediate System 20 must first establish communication with the alternate Intermediate System 30 and will thence follow the method as described earlier. The alternate Intermediate System 30 will handle requests on behalf of the Intermediate System 20 to which the original requester 24 is connected.

In the foregoing manner, a system and method for managing access to a plurality of Mobile Data Devices connected to a network using an intermediate system is described in accordance to the present invention for addressing the foregoing disadvantages of conventional Mobile Data Device access methods. It will be apparent to one skilled in the art in view of this disclosure that numerous changes and/or modification can be made without departing from the scope and spirit of the invention.

What is claimed is:

1. A system for managing access to one or more mobile data collection device(s), the system comprising:
a mobile communication network;
one or more mobile data collection device(s) connectable to said mobile communication network; and
an intermediate system connectable to said mobile communication network;
wherein said intermediate system is operable to:
a) assign each said one or more mobile data collection device(s) with a unique name and register each said unique mobile data collection device in a lookup table in a database;
b) register one or more data requestor(s) and create an access list of mobile data collection device(s) for each said data requester; and
c) when a data request is received by the mobile communication network and access right of the requester is verified from said access list, direct the relevant mobile data collection device to respond, so that the data requester has no knowledge of the identity and availability of the responding mobile data collection device.

2. A system according to claim 1, wherein said communication network is connectable to another communication network, said another communication network has an associated intermediate system; one or more associated data collection device(s); and one or more data requestor(s), such that said associated intermediate system is operable to:
a1) assign each said one or more associated data collection device(s) with a unique name and register each said unique associated data collection device in a lookup table in a database;
b1) register said one or more data requestor(s) and create an access list of data collection device(s) for each said data requester; and
c1) when a data request is received by said communication network and access right of the requester is verified from said access list, direct the relevant data collection device to respond, so that the data requestor has no knowledge of the identity and availability of the responding data collection device.

3. A system according to claim 2, wherein said mobile communication network and said another communication network comprise communication networks that operate on similar protocols.

4. A system according to claim 2, wherein said communication network and said another communication network comprise communication networks that operate on different protocols.

5. A system according to claim 2, wherein said intermediate system and said another intermediate system are in communication, so that a data requester on one communication network is allowed to access a data collection device disposed on said another communication network.

6. A system according to claim 5, wherein communication between said intermediate system and said another intermediate system is made via a shared network, such as, the internet.

7. A system according to claim 1, wherein access to said mobile data collection device is initiated by a data request, initiated by an event or triggered by a stimulus.

8. A system according to claim 7, wherein said stimulus comprises any one of the following: motion detection, change in temperature, change in humidity, change in count, and trigger from an instrument/controller.

9. A system according to claim 1, wherein response from a mobile data collection device is directed through said intermediate system for updating availability of the mobile data collection device in said lookup table.

10. A system according to claim 1, wherein registering said mobile data collection device further comprises identifying said mobile data collection device by its MSISDN, IMEI and/or IP address.

11. A system according to claim 1, wherein said unique name of each said mobile data collection device comprises a content description of the data provided by said mobile data collection device.

12. A system according to claim 1, wherein said unique name of each said data collection device comprises a content category of the data provided by said data collection device.
